(19) United States
(12) Patent Application Publication
(10) Pub. No.: US 2024/0172281 A1
(43) Pub. Date: May 23, 2024

(54) APPARATUS, SYSTEM, AND METHOD OF MULTI-LINK OPERATION (MLO) WITH A MILLIMETER WAVE (MMWAVE) LINK

(71) Applicants: Laurent Cariou, Milizac (FR); Thomas Kenney, Portland, OR (US)

(72) Inventors: Laurent Cariou, Milizac (FR); Thomas Kenney, Portland, OR (US)

(21) Appl. No.: 18/399,387

(22) Filed: Dec. 28, 2023

(51) Int. Cl. H04W 74/0816; H04B 7/06; H04W 74/08

(52) U.S. Cl. CPC H04W 74/0816; H04B 7/0617; H04W 74/0866

(57) ABSTRACT

For example, a non Access Point (AP) (non-AP) Multi-Link Device (MLD) may operate at an Enhanced Multi-Link Single Radio (EMLSR) operation mode of a Multi-Link Operation (MLO) over a plurality of links with an AP MLD, for example, based on a determination that the non-AP MLD is to operate over a millimeter Wave (mmWave) frequency band. For example, the plurality of links may include a sub 10 Gigahertz (GHz) (sub-10 GHz) link over a sub-10 GHz frequency band and an mmWave link over the mmWave frequency band. For example, the non-AP MLD may be configured to listen over the plurality of links to identify an Initial Control Frame (ICF) from the AP MLD; and to identify, based on detection of the ICF from the AP MLD over the mmWave link, that a Transmit Opportunity (TxOP) is to be established to communicate traffic with the AP MLD over the mmWave link.

### BACKGROUND

Devices in a wireless communication system may be configured to communicate over a millimeter Wave (mmWave) wireless communication channel.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic flow-chart illustration of a method of Multi Link Operation (MLO) with a millimeter-Wave (mmWave) link, in accordance with some demonstrative aspects.

FIG. 5 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D5.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), November 2023)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a sub-7 GHz frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 40 GHz, for example, a frequency band above 45 GHz, e.g., a 60 GHz frequency band, a frequency band between 42.5 GHz and 71 GHz, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by a mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

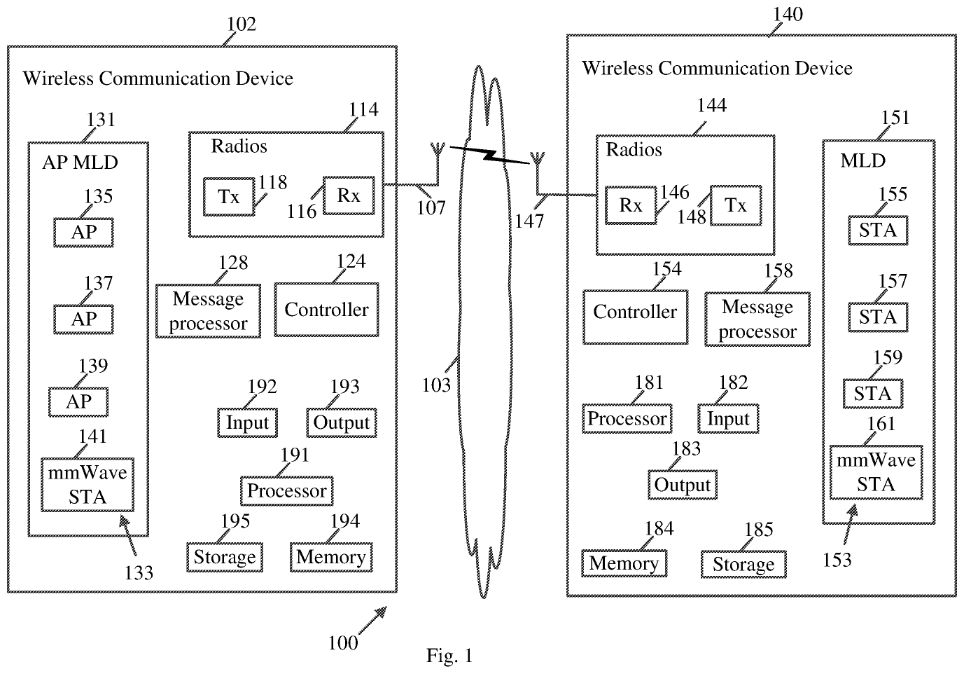

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102, and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, one or more channels in a sub-7 GHz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band, for example, one or more channels in a frequency band above 40 GHz, for example, one or more channels in a frequency band above 45 GHz, e.g., one or more channels in a 60 GHz frequency band, one or more channels in a frequency band between 42.5 GHz and 71 GHz, and/or one or more channels in any other mmWave frequency band.

In other aspects, WM 103 may include any other type of channel over any other frequency band.

In some demonstrative aspects, device 102 and/or device 140 may include one or more radios including circuitry and/or logic to perform wireless communication between devices 102, 140, and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a sub-10 GHz band, for example, a sub-7 GHz band, for example, a 2.4 GHz band, a 5 GHz band, a 6 GHz band, and/or any other sub-10 GHz and/or sub-7 GHz band; and/or an mmWave band, e.g., a 45 GHz band, a 60 GHz band, a band between 42.5 Ghz and 71 GHz, and/or any other mmWave band; and/or any other band, e.g., a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102 and/or device 140 may be configured to perform one or more operations, and/or functionalities of a WiFi 8 STA.

In other aspects, for example, devices 102 and/or 140 may be configured to perform one or more operations, and/or functionalities of an Ultra High Reliability (UHR) STA.

In other aspects, for example, devices 102 and/or 140 may be configured to perform one or more operations, and/or functionalities of an Integrated mmWave (IMMW) STA.

In other aspects, for example, devices 102 and/or 140 may be configured to perform one or more operations, and/or functionalities of any other additional or alternative type of STA.

In other aspects, devices 102, and/or 140 may include, operate as, perform the role of, and/or perform one or more functionalities of, any other wireless device and/or station, e.g., a WLAN STA, a WiFi STA, and the like.

In some demonstrative aspects, device 102 and/or device 140 may be configured to operate as, perform the role of, and/or perform one or more functionalities of, an access point (AP), e.g., an EHT AP STA, a UHR AP STA, and/or an IMMW AP STA.

In some demonstrative aspects, device 102 and/or device 140 may be configured to operate as, perform the role of, and/or perform one or more functionalities of, a non-AP STA, e.g., an EHT non-AP STA, a UHR non-AP STA, and/or an IMMW non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, a UHR network, an IMMW network, and/or any other network.

In some demonstrative aspects, devices 102, 140 and/or 150 may be configured to operate in accordance with one or more Specifications, for example, including one or more IEEE 802.11 Specifications, e.g., an IEEE 802.11-2020 Specification, an IEEE 802.11be Specification, and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to control, perform and/or to trigger, cause, instruct and/or control device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, a mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 GHz band, as described below.

In some demonstrative aspects, for example, the one or more radios 114 may include, for example, a radio for communication by AP STA 137 over a second wireless communication frequency channel and/or frequency band, e.g., a 5 GHz band, as described below.

In some demonstrative aspects, for example, the one or more radios 114 may include, for example, a radio for communication by AP STA 139 over a third wireless communication frequency channel and/or frequency band, e.g., a 6 GHz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 40 GHz, for example, a frequency band above 45 GHz, e.g., a 60 GHz frequency band, a frequency band between 42.5 GHz and 71 GHz, and/or any other mmWave frequency band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects controller 124 may be configured to control, perform and/or to trigger, cause, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, perform and/or to trigger, cause, instruct and/or control device 140 to operate as, perform a role of, and/or perform one or more operations and/or functionalities of, an MLD 151 including a plurality of STAs 153, e.g., including a STA 155, a STA 157, a STA 159, and/or a STA 161. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 GHz band, as described below.

In some demonstrative aspects, for example, the one or more radios 144 may include, for example, a radio for communication by STA 157 over a second wireless communication frequency channel and/or frequency band, e.g., a 5 GHz band, as described below.

In some demonstrative aspects, for example, the one or more radios 144 may include, for example, a radio for communication by STA 159 over a third wireless communication frequency channel and/or frequency band, e.g., a 6 GHz band, as described below.

In some demonstrative aspects, for example, the one or more radios 144 may include, for example, a radio for communication by mmWave STA 161 over a fourth wireless communication frequency channel and/or frequency band, e.g., a mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, perform and/or to trigger, cause, instruct and/or control MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, perform and/or to trigger, cause, instruct and/or control MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects controller 154 may be configured to control, perform and/or to trigger, cause, instruct and/or control device 140 to operate as, perform a role of, and/or perform one or more operations and/or functionalities of, any other additional or alternative entity and/or STA, e.g., a single STA, multiple STAs, and/or a non-MLD entity.

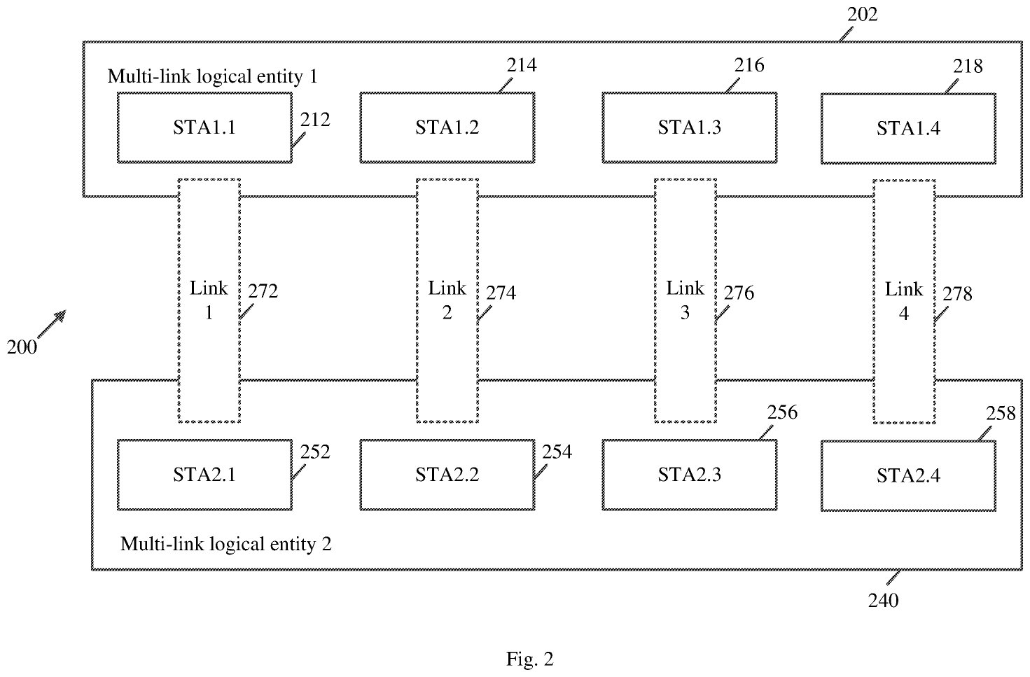

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

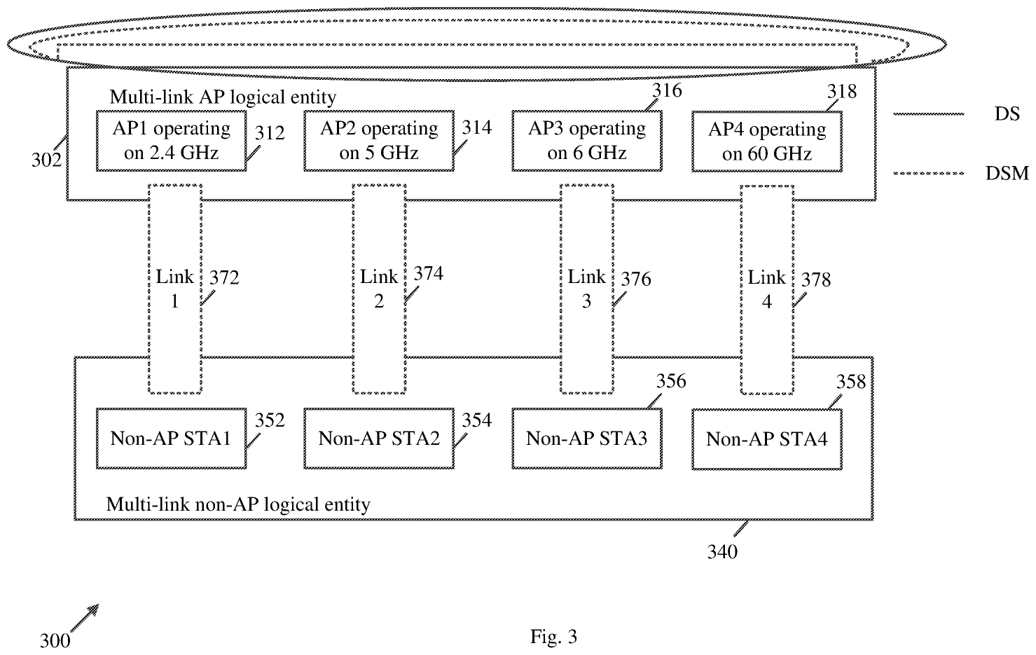

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 GHz frequency band, AP STA 314 may be configured to communicate over a 5 GHz frequency band, AP STA 316 may be configured to communicate over a 6 GHz frequency band, and/or mmWave STA 318 may be configured to communicate over a mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, device 102 and/or device 140 may be configured to implement one or more operations and/or functionalities of a Multi-Link Operation (MLO) mechanism, which may be configured to support wireless communication over a mmWave link, e.g., as described below.

In some demonstrative aspects, device 102 and/or device 140 may be configured to implement one or more operations and/or functionalities of an MLO mechanism, which may be configured to provide a technical solution to support mmWave operation, e.g., operation at a mmWave band, for example, together with, a sub-10 GHz functionality, for example, according to a suitable mainstream Wi-Fi protocol, e.g., as described below.

In some demonstrative aspects, device 102 and/or device 140 may be configured to implement one or more operations and/or functionalities of an MLO mechanism, which may be configured to provide a technical solution to support reuse of at least some components of, e.g., as much as possible of, the same baseband, for communications by both a sub-10 GHz radio, e.g., a regular Wi-Fi radio, and a mmWave radio, e.g., a 60 GHz radio, e.g., as described below.

In some demonstrative aspects, device 102 and/or device 140 may be configured to implement one or more operations and/or functionalities of an MLO mechanism, which may be configured based on, and/or may utilize, a multi-link framework, for example, according to an MLD architecture, e.g., as described above.

In some demonstrative aspects, device 102 and/or device 140 may be configured to implement one or more operations and/or functionalities of an MLO mechanism, which may be configured to provide a technical solution to support an Integrated mmWave (IMMW) technology, for example, to define a WiFi interface for communication over a mmWave band, e.g., as described below.

For example, the IMMW technology may be configured to provide a technical solution to reduce complexity, e.g., as low complexity as possible, for example, by reusing in the mmWave band at least some, e.g., most, of a PHY PPDU structure and/or a PHY procedure as in a lower band, e.g., the sub-10 GHz band.

For example, it may be defined, e.g., according to the IMMW technology, that a device may not be allowed to operate as an mmWave-only device.

For example, it may be defined, e.g., according to the IMMW technology, that an IMMW device, e.g., an IMMW STA, may be configured to support the use of an mmWave link in the mmWave band, for example, together with a sub-10 GHz link in the sub-10 GHz bend, e.g., in the lower bands of 2.4 GHz, 5 GHz, and/or 6 GHz.

For example, it may be defined, e.g., according to the IMMW technology, that an IMMW device, e.g., an IMMW STA, may be configured to support Multi-Link Operation (MLO), e.g., in accordance with an IEEE 802.11be Specification.

For example, it may be defined, e.g., according to the IMMW technology, that an IMMW device, e.g., an IMMW STA, may be configured to utilize the MLO, for example, to provide a technical solution to support significant reduction in complexity of an mmWave interface, for example, by using a link in a lower band, e.g., a sub-10 GHz link, to support the mmWave link.

For example, it may be defined, e.g., according to the IMMW technology, that an IMMW device, e.g., an IMMW STA, may be configured to utilize communications over the sub-10 GHz band, for example, for discovery, association, broadcast transmissions, or the like.

For example, it may be defined, e.g., according to the IMMW technology, that an IMMW device, e.g., an IMMW STA, may be configured to selectively restrict communications over the mmWave based on one or more restrictions and/or conditions.

For example, it may be defined, e.g., according to the IMMW technology, that an IMMW device, e.g., an IMMW STA, may be configured to only use the mmWave link, e.g., when needed for data transmissions.

In some demonstrative aspects, device 102 and/or device 140 may be configured to implement one or more operations and/or functionalities of an MLO mechanism, which may be configured to provide a technical solution to support improved robustness of an mmWave link, e.g., as described below.

For example, a mmWave link may suffer from a robustness limitation, for example, as the mmWave link may be broken more often, e.g., due to blockage or interference.

In some demonstrative aspects, device 102 and/or device 140 may be configured to implement one or more operations and/or functionalities of an MLO mechanism, which may implement one or more operations and/or functionalities for communication at an Enhanced Multilink Single-Radio (EMLSR) operation mode, e.g., in accordance with an IEEE 802.11 Specification and/or a Wi-Fi7 Specification, e.g., as described below.

In some demonstrative aspects, the EMLSR operation mode may be defined, e.g., in compliance with an IEEE 802.11be Specification, to include a mode of operation that allows a non-AP MLD with multiple receive chains to listen on a set of enabled links, for example, when the corresponding STAs affiliated with the non-AP MLD are in the awake state, for an initial control frame sent by an AP affiliated with an AP MLD.

For example, the initial control frame may be sent by the AP in a non-high-throughput (non-HT) (duplicate) PPDU, for example, with one spatial stream. In other aspects, the initial control frame may be sent according to any other suitable format and/or configuration.

For example, the initial control frame may be followed by one or more frame exchanges on the link on which the initial control frame was received.

In other aspects, the EMLSR operation mode may be defined to include any other additional or alternative suitable functionality.

Some demonstrative aspects are described herein with respect to a wireless communication device, e.g., wireless communication device 140, operating according to an EMLSR operation mode. Other aspects may be implemented with respect to a wireless communication device, e.g., wireless communication device 140, operating according to any other additional or alternative multi-link operation mode.

For example, an EMLSR STA may include a STA that may listen to multiple links at the same time, and then switch to one link for frame exchanges, e.g., as described below.

For example, it may be defined, e.g., in accordance with an IEEE 802.11be Specification, that for DL traffic on a particular link, an AP may be required to send to the EMLSR STA a Multi-User Request to Send (MU-RTS) trigger frame, or a Buffer Status Report Poll (BSRP) trigger frame, as an Initial Control Frame (ICF), for example, prior to the DL traffic, for example, such that the EMLSR STA may be triggered to switch to the link and receive the DL traffic from the AP. In other aspects, the ICF may include any other additional or alternative type of frame.

In some demonstrative aspects, device 102 and/or device 140 may be configured to implement one or more operations and/or functionalities of an MLO mechanism, which may utilize the EMLSR operation mode, for example, by configuring an EMLSR link set to include at least one mmWave link over the mmWave band, and at least one sub-10 GHz link over the sub-10 GHz band, e.g., as described below.

In some demonstrative aspects, controller 154 may be configured to control, trigger, cause, and/or instruct a non-AP MLD implemented by device 140 to determine that the non-AP MLD is to operate over an mmWave frequency band, e.g., as described below.

In some demonstrative aspects, controller 154 may be configured to control, trigger, cause, and/or instruct the non-AP MLD implemented by device 140 to, for example, based on a determination that the non-AP MLD is to operate over an mmWave frequency band, operate the non-AP at an EMLSR operation mode of an MLO over a plurality of links with an AP MLD, for example, an AP MLD implemented by device 102, e.g., as described below.

In some demonstrative aspects, the plurality of links of the EMLSR mode may include a sub-10 GHz link over a sub-10 GHz frequency band, and an mmWave link over the mmWave frequency band, e.g., as described below.

In some demonstrative aspects, controller 154 may be configured to control, trigger, cause, and/or instruct the non-AP MLD implemented by device 140 to listen over the plurality of links, for example, to identify an Initial Control Frame (ICF) from the AP MLD, e.g., as described below.

In some demonstrative aspects, controller 154 may be configured to control, trigger, cause, and/or instruct the non-AP MLD implemented by device 140 to identify that a Transmit Opportunity (TxOP) is to be established to communicate traffic with the AP MLD over the mmWave link, for example, based on detection of the ICF from the AP MLD over the mmWave link, e.g., as described below.

In some demonstrative aspects, the non-AP MLD may include an Integrated mmWave (IMMW) non-AP MLD.

In other aspects, the non-AP MLD may include any other additional or alternative type of A MLD.

In some demonstrative aspects, the sub-10 GHz link may include a sub-7 GHz link over a sub-7 GHz frequency band, e.g., as described below.

In other aspects, the sub-10 GHz link may include any other additional or alternative link over the sub-10 GHz frequency band.

In some demonstrative aspects, the mmWave link may be over a channel having a frequency above 40 GHz, e.g., as described below.

In other aspects, the mmWave link may include any other additional or alternative link over the mmWave frequency band.

In some demonstrative aspects, the mmWave frequency band may include a frequency band between 42.5 GHz and 71 GHz.

In other aspects, any other additional or alternative suitable mmWave frequency band may be implemented.

In some demonstrative aspects, controller 154 may be configured to control, trigger, cause, and/or instruct the non-AP MLD implemented by device 140 to operate over the mmWave frequency band, for example, only at the MLO over the plurality of links including at least one sub-10 GHz link and at least one mmWave link, e.g., as described below.

In some demonstrative aspects, controller 154 may be configured to control, trigger, cause, and/or instruct the non-AP MLD implemented by device 140 to mandate the MLO over the plurality of links including at least one sub-10 GHz link and at least one mmWave link, for example, when the non-AP MLD is intended to operate over the mmWave frequency band, e.g., as described below.

In some demonstrative aspects, controller 154 may be configured to control, trigger, cause, and/or instruct the non-AP MLD implemented by device 140 to restrict operation of the non-AP MLD over the mmWave frequency band, for example, to be performed only as part of the MLO over the plurality of links including at least one sub-10 GHz link and at least one mmWave link, e.g., as described below.

In some demonstrative aspects, controller 154 may be configured to control, trigger, cause, and/or instruct the non-AP MLD implemented by device 140 to restrict the non-AP MLD to operate over the mmWave frequency band, for example, only at the EMLSR operation mode, e.g., as described below.

In some demonstrative aspects, controller 154 may be configured to control, trigger, cause, and/or instruct the non-AP MLD implemented by device 140 to listen over the sub-10 GHz link for another ICF from the AP MLD, for example, during at least part of the TxOP over the mmWave link, e.g., as described below.

In some demonstrative aspects, controller 154 may be configured to control, trigger, cause, and/or instruct the non-AP MLD implemented by device 140 to switch from the mmWave link to the sub-10 GHz link for communication with the AP MLD, for example, based on a detection of the other ICF from the AP MLD during the TxOP over the mmWave link, e.g., as described below.

In some demonstrative aspects, controller 154 may be configured to control, trigger, cause, and/or instruct the non-AP MLD implemented by device 140 to identify the ICF from the AP MLD according to an mmWave ICF format configured for the mmWave frequency band, e.g., as described below.

In some demonstrative aspects, the mmWave ICF format may be different from a sub-10 GHz ICF format of the ICF configured for the sub-10 GHz frequency band, e.g. as described below.

In some demonstrative aspects, the mmWave ICF format may define the ICF over the mmWave frequency band to be shorter in duration that the ICF configured for the sub-10 GHz frequency band.

In some demonstrative aspects, the mmWave ICF format may define the ICF over the mmWave frequency band to utilize a frame type different from a frame type of the ICF configured for the sub-10 GHz frequency band.

In some demonstrative aspects, the mmWave ICF format may define the ICF over the mmWave frequency band to utilize a transmission scheme different from a transmission scheme of the ICF configured for the sub-10 GHz frequency band.

In some demonstrative aspects, the mmWave ICF format may define the ICF over the mmWave frequency band to utilize a data rate different from a data rate of the ICF configured for the sub-10 GHz frequency band.

In some demonstrative aspects, controller 154 may be configured to control, trigger, cause, and/or instruct the non-AP MLD implemented by device 140 to configure the plurality of links of the EMLSR operation mode to include a first mmWave link and a second mmWave link, e.g., as described below.

In some demonstrative aspects, controller 154 may be configured to control, trigger, cause, and/or instruct the non-AP MLD implemented by device 140 to configure the first mmWave link and the second mmWave link over a same mmWave channel, e.g., as described below.

In other aspects, the first mmWave link and the second mmWave link may be configured over different mmWave channels.

In some demonstrative aspects, controller 154 may be configured to control, trigger, cause, and/or instruct the non-AP MLD implemented by device 140 to configure the first mmWave link and the second mmWave link having a same channel Bandwidth (BW), e.g., as described below.

In other aspects, the first mmWave link and the second mmWave link may be configured to have different channel BWs.

In some demonstrative aspects, controller 154 may be configured to control, trigger, cause, and/or instruct the non-AP MLD implemented by device 140 to configure the first mmWave link via a first antenna array of the non-AP MLD, and to configure the second mmWave link via a second antenna array of the non-AP MLD, e.g., as described below.

In some demonstrative aspects, the first antenna array of the non-AP MLD may be in a first direction, and the second antenna array of the non-AP MLD may be in a second direction, e.g., different from the first direction.

In other aspects, the first mmWave link and the second mmWave link may be configured via a same antenna array of the non-AP MLD.

In some demonstrative aspects, controller 154 may be configured to control, trigger, cause, and/or instruct the non-AP MLD implemented by device 140 to configure the first mmWave link via a first antenna sector in a first direction from the non-AP MLD, and to configure the second mmWave link via a second antenna sector in a second direction from the non-AP MLD, e.g., as described below.

In other aspects, the first mmWave link and the second mmWave link may be configured via any other suitable antenna sector configuration.

In some demonstrative aspects, controller 154 may be configured to control, trigger, cause, and/or instruct the non-AP MLD implemented by device 140 to listen for the ICF over the first mmWave link and the second mmWave link substantially simultaneously, e.g., as descried below.

In some demonstrative aspects, controller 154 may be configured to control, trigger, cause, and/or instruct the non-AP MLD implemented by device 140 to mandate the non-AP MLD to configure the plurality of links of the EMLSR operation mode to include the first mmWave link and the second mmWave link, e.g., as described below.

In other aspects, implementation of the first mmWave link and the second mmWave link may be optional.

In some demonstrative aspects, controller 154 may be configured to control, trigger, cause, and/or instruct the non-AP MLD implemented by device 140 to configure the mmWave link according to a Multiple-Input-Multiple-Output (MIMO) beamforming setting, e.g., as described below.

In some demonstrative aspects, controller 154 may be configured to control, trigger, cause, and/or instruct the non-AP MLD implemented by device 140 to configure the mmWave link according to a MIMO beamforming setting, for example, in first and second different directions, e.g., as described below.

In some demonstrative aspects, controller 154 may be configured to control, trigger, cause, and/or instruct the non-AP MLD implemented by device 140 to listen for the ICF in both the first and second different directions, for example, substantially simultaneously, e.g., as described below.

In some demonstrative aspects, controller 154 may be configured to control, trigger, cause, and/or instruct the non-AP MLD implemented by device 140 to process a field in the ICF from the AP MLD, for example, to identify an antenna index of the AP MLD, e.g., as described below.

In some demonstrative aspects, controller 154 may be configured to control, trigger, cause, and/or instruct the non-AP MLD implemented by device 140 to determine which of the first and second different directions is to be used to establish the TxOP over the mmWave link, for example, based on the antenna index of the AP MLD, e.g., as described below.

In some demonstrative aspects, device 102 and/or device 140 may be configured to implement one or more operations and/or functionalities of an MLO mechanism, which may utilize the EMLSR operation mode, for example, with at least one link of an EMLSR link set being in the mmWave band, and at least one link of the EMLSR link set being in a lower band, e.g., a 2.4 GHz link in a 2.4 GHz band, a 5 GHz link in a 5 GHz band, and/or a 6 GHz link in a 6 GHz band, e.g., as described below.

In some demonstrative aspects, one or more operations and/or functionalities of the EMLSR mode, e.g., in accordance with an IEEE 802.11be Specification, may be reused, e.g., with substantially no changes or some changes, for example, for the mmWave link over the mmWave frequency band.

For example, it may be defined that at the EMLSR operation mode a structure of a TxOP over the mmWave link may start, e.g., may be mandated to always start, with an initial control frame, e.g., an MU-RTS frame or and/or any other suitable frame type defined as an ICF for the mmWave frequency band.

In some demonstrative aspects, a new initial control frame may be define, for example, specifically for the mmWave frequency band.

For example, the initial control frame for the mmWave frequency band may be configured according to an mmWave ICF format, which may be configured to provide a technical solution to support the non-AP MLD in listening over the mmWave link, and/or to support the non-AP MLD in detecting the mmWave ICF over the mmWave link.

For example, mmWave ICF format may define an mmWave ICF having a shorter duration, e.g., compared to a duration of an ICF communicated over the sub-10 GHz link.

For example, mmWave ICF format may be configured to provide a technical solution to support improved power save performance, for example, during the listen operation over the mmWave link. For example, the mmWave ICF format may be configured to support improved power performance of the non-AP MLD, for example, during the time when the non-AP MLD is to wait for the ICF to be received over the mmWave link.

In some demonstrative aspects, one or more operations and/or functionalities of the EMLSR mode, e.g., in accordance with an IEEE 802.11be Specification, may be reused, e.g., with substantially no changes or some changes, for example, for ending a TxOP over the mmWave link and returning to a listening operation over the link set of the EMLSR operation mode.

In some demonstrative aspects, it may be defined that, in case the non-AP MLD is at the EMLSR operation mode, and the non-AP MLD detects a an initial control frame on the mmWave link, then the non-AP MLD may, e.g., shall be mandated to, continue to maintain the listen operation over the sub-10 GKz link.

In some demonstrative aspects, the non-AP MLD may be configured to continue to maintain the listen operation over the sub-10 GKz link, e.g., after starting the TxOP over the mmWave link, for example, to provide a technical solution to allow the non-AP MLD to be ready to receive another initial control frame, e.g., over the sub-10 GHz link, for example, in case the transmission in the mmWave link is not successful or is not as successful as expected.

In some demonstrative aspects, device 102 and/or device 140 may be configured to implement one or more operations and/or functionalities of an MLO mechanism, which may utilize the EMLSR operation mode, for example, with two mmWave links, e.g., as described below.

In some demonstrative aspects, device 102 and/or device 140 may be configured to implement one or more operations and/or functionalities of an MLO mechanism, which may utilize the EMLSR operation mode, for example, with two mmWave links, for example, on one channel in the mmWave operation, e.g., as described below.

In some demonstrative aspects, the EMLSR operation mode may be expanded, for example, to support use of two mmWave links, for example, in the mmWave band, for example, in an mmWave channel, e.g., as described below.

In some demonstrative aspects, it may be defined that an MLD, e.g., a non-AP MLD and/or an AP MLD, may be allowed to have two mmWave links on the same mmWave channel(s), e.g., simultaneously.

In some demonstrative aspects, it may be defined that an MLD, e.g., a non-AP MLD and/or an AP MLD, may operate as a 3-link MLD, which may have three MLD links, for example, including two mmWave links and a sub-10 GHz link, e.g., as described below.

In other aspects, an MLD, e.g., a non-AP MLD and/or an AP MLD, may have more than three MLD links, e.g., including at least two mmWave links and one or more sub-10 GHz links.

In some demonstrative aspects, the MLD, e.g., the non-AP MLD and/or the AP MLD, may be allowed to operate the two mmWave links on the same mmWave channel, e.g., as described below.

In some demonstrative aspects, the MLD, e.g., the non-AP MLD and/or the AP MLD, may be configured to utilize two antenna arrays to maintain the two mmWave links, e.g., simultaneously, for example, over the same mmWave channel. For example, a first antenna array may be used for a first mmWave link, and a second antenna array may be used for a second mmWave link.

In some demonstrative aspects, the MLD, e.g., the non-AP MLD and/or the AP MLD, may be configured to utilize the two antenna arrays to listen on both the first and second mmWave links, e.g., substantially simultaneously.

In some demonstrative aspects, the MLD, e.g., the non-AP MLD and/or the AP MLD, may be configured to utilize the two antenna arrays to perform a start of packet detection on both the first and second mmWave links.

In some demonstrative aspects, the MLD, e.g., the non-AP MLD and/or the AP MLD, may be configured to lock reception to one particular mmWave link of the two mmWave links, for example, once a start of packet is detected on the particular mmWave link.

For example, the implementation of the two antenna arrays to perform the start of packet detection on both the first and second mmWave links may provide a technical solution to reduce complexity, for example, by allowing to avoid having two completely separate parallel PHY and MAC reception processes implemented by the MLD.

In some demonstrative aspects, the MLD, e.g., the non-AP MLD and/or the AP MLD, may be configured to utilize the two antenna arrays, for example, with sufficient separation, for example, in space and/or polarization, for example, to provide nearly independent channels for detection of the initial control frame.

In some demonstrative aspects, a non-AP MLD, e.g., the non-AP MLD implemented by device 140, may be configured to perform beamforming training with an AP MLD, e.g., the AP MLD implemented by device 102, on the two mmWave links, for example, by separately performing the beamforming on each link.

In some demonstrative aspects, the non-AP MLD, e.g., the non-AP MLD implemented by device 140, may be configured to choose, e.g., based on the beamforming, two preferred sectors for the two mmWave links.

In some demonstrative aspects, the non-AP MLD, e.g., the non-AP MLD implemented by device 140, may be configured to choose the two sectors for the mmWave links to include two sectors that are intentionally in substantially different directions. For example, selecting the two beamformed sectors to be in substantially different directions may provide a technical solution to support improved robustness. For example, when the two beamformed sectors are selected to be in substantially different directions, then in case one mmWave link suffers from a blockage, there may be less probability that the second link may also suffers from the same blockage.

In some demonstrative aspects, the non-AP MLD, e.g., the non-AP MLD implemented by device 140, may be configured to use the EMLSR operation mode, for example, with a set of EMLSR links including the two mmWave links, for example, to provide a technical solution to address an issue of link blockage, e.g., over the mmWave frequency band. For example, in case one of the mmWave links suffers from blockage, the non-AP MLD may switch to use the other mmWave link, e.g., as quickly as possible.

In some demonstrative aspects, configuring the EMLSR operation mode, for example, with a set of EMLSR links including the two mmWave links, may provide a technical solution to exploit a multi-antenna dimensionality, for example, to improve reliability of the mmWave link.

For example, the MLO and the EMLSR operation mode may be configured to support the set of EMLSR links including the two mmWave links, e.g., as described above, for example, to provide a technical solution to improve reliability of the mmWave communication.

For example, configuring the EMLSR operation mode, for example, with a set of EMLSR links including the two mmWave links, may provide a technical solution to improve reliability of the mmWave communication, for example, even without defining support of a MIMO operation, e.g., as part of the IMMW functionality.

In some demonstrative aspects, the IMMW functionality may be configured to support MIMO operation. For example, it may be defined that an IMMW non-AP STA and/or an IMMW AP may be allowed, or may be required to, support MIMO operation, e.g., over the mmWave band.

In some demonstrative aspects, it may be defined, for example, that an IMMW non-AP STA and/or an IMMW AP may support a mode of operation where MIMO beamforming training may be performed on the mmWave link, for example, to select a plurality of best sectors for an antenna, e.g., for each antenna.

In some demonstrative aspects, it may be defined, for example, that the MIMO beamforming training may be performed on the mmWave link, for example, to select the plurality of best sectors for the antenna, for example, such that the plurality of best sectors for the antenna, e.g., for each antenna, point as much as possible in different directions.

For example, this mode of selecting the sectors of the antenna to point as much as possible in different directions may be implemented to provide a technical solution to address cases of link blockage. For example, configuring the sectors of the antenna to point to substantially different directions may increase the probability that if one direction suffers from blockage, then the other direction may not suffer as well from the same blockage.

In some demonstrative aspects, it may be defined that an IMMW device, e.g., an IMMW device implemented by device 140, for example, an IMMW MLD, e.g., a non-AP MLD implemented by device 140, may be capable of supporting a MIMO mode of operation, for example, to utilize the two antenna sectors beamformed in the two different directions, for example, to listen on both the first and second mmWave links, e.g., substantially simultaneously.

In some demonstrative aspects, the IMMW device e.g., the IMMW device implemented by device 140, may be capable of supporting the MIMO mode of operation, for example, to utilize the two antenna sectors in the two different direction, for example, to perform a start of packet detection on both the first and second mmWave links.

In some demonstrative aspects, the IMMW device e.g., the IMMW device implemented by device 140, may be capable of supporting the MIMO mode of operation, for example, to determine over which antenna a start of packet is detected, for example, when a start of packet is detected on a particular mmWave link of the two mmWave links.

In some demonstrative aspects, the IMMW device e.g., the IMMW device implemented by device 140, may be capable of supporting the MIMO mode of operation, for example, to lock reception to the determined antenna, for example, to receive the detected PPDU and to communicate during an induced TxOP based on the detected PPDU.

In some demonstrative aspects, it may be defined that the IMMW device e.g., the IMMW device implemented by device 140, may utilize the EMLSR operation mode, for example, to start a TxOP in the mmWave frequency band, e.g., to start every TxOP in the mmWave frequency band, for example, with an initial control frame.

For example, it may be defined that the IMMW device e.g., the IMMW device implemented by device 140, may be allowed to operate in the mmWave frequency band, for example, by utilizing the EMLSR operation mode of the MLO with an EMLSR link set including the two mmWave links configured according to the MIMO operation, e.g., as described above.

For example, it may be defined that the IMMW device e.g., the IMMW device implemented by device 140, may listen over the EMLSR link set, for example, to detect the initial control frame over an mmWave link, for example, prior to starting a TxOP, e.g., any TxOP, in the mmWave frequency band, e.g., as described above.

In some demonstrative aspects, it may be defined, for example, that the initial control frame is to be configured to indicate an antenna index used by a PPDU including the initial control frame.

For example, the initial control frame may be configured to indicate an antenna index of an antenna and/or antenna sector of an AP, e.g., the AP implemented y device 102, which is used for transmission of the initial control frame.

For example, the initial control frame may be configured to indicate the antenna index of the antenna and/or antenna sector of the AP, which may be used for transmission of the initial control frame, and for transmission of one or more additional PPDUs, e.g., during a TxOP to be setup based on the initial control frame.

In one example, the initial control frame may be configured to include an antenna index field to indicate the antenna index of the antenna and/or the antenna sector of the AP used to transmit the initial control frame.

For example, the IMMW device e.g., the IMMW device implemented by device 140, may be configured to use the indication of the antenna index of the antenna and/or antenna sector of the AP, for example, to identify which antenna sector of the IMMW device and/or which mmWave link is to be used for a TxOP triggered by the initial control frame.

For example, the IMMW device e.g., the IMMW device implemented by device 140, may be configured to use the indication of the antenna index of the antenna and/or antenna sector of the AP, for example, in case the IMMW device does not have a capability to determine on its own which antenna sector of the IMMW device and/or which mmWave link is to be used.

In some demonstrative aspects, it may be defined that an initiator device, which is to initiate a TxOP over the mmWave frequency band, e.g., the AP implemented by device 102, may select at the start of the TxOP, e.g., each TxOP, to use one antenna or another antenna, for example, to avoid blockage.

In some demonstrative aspects, it may be defined that an initiator device may select to use both antennas, for example, if MIMO is to be performed.

In some demonstrative aspects, it may be defined that an IMMW device may utilize a mode of operation, which may be defined as an intermediate mode, e.g., between SISO and MIMO support. For example, the intermediate mode may be implemented by a responder device, e.g., a responder device implemented by device 140, which may not be capable to transmit/receive jointly on two antennas, but may be able to perform one or the other.

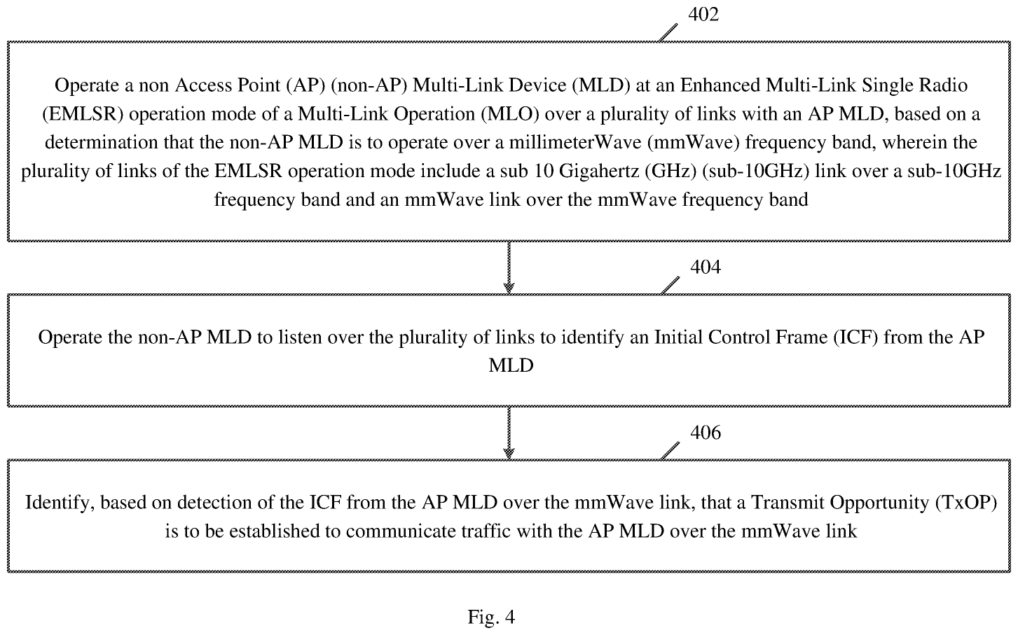

Reference is made to FIG. 4, which schematically illustrates a method of MLO with a millimeter Wave (mmWave) link, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include operating a non-AP MLD at an EMLSR operation mode of a MLO over a plurality of links with an AP MLD, for example, based on a determination that the non-AP MLD is to operate over an mmWave frequency band. For example, the plurality of links of the EMLSR operation mode may be configured to include a sub-10 GHz link over a sub-10 GHz frequency band and an mmWave link over the mmWave frequency band. For example, controller 154 (FIG. 1) may be configured to cause, trigger, and/or control a non-AP MLD implemented by device 140 (FIG. 1) to operate at the EMLSR operation mode of thee MLO over the plurality of links including the sub-10 GHz link over the sub-10 GHz frequency band and the mmWave link over the mmWave frequency band, for example, based on a determination that the non-AP MLD is to operate over the mmWave frequency band, e.g., as described above.

As indicated at block 404, the method may include listening over the plurality of links to identify an ICF from the AP MLD. For example, controller 154 (FIG. 1) may be configured to cause, trigger, and/or control the non-AP MLD implemented by device 140 (FIG. 1) to listen over the plurality of links of the EMLSR operation mode for an ICF from the AP MLD implemented by device 102 (FIG. 1), e.g., as described above.

As indicated at block 406, the method may include identifying, for example, based on detection of the ICF from the AP MLD over the mmWave link, that a TxOP is to be established to communicate traffic with the AP MLD over the mmWave link. For example, controller 154 (FIG. 1) may be configured to cause, trigger, and/or control device 140 (FIG. 1) to identify, for example, based on detection of the ICF from the AP MLD implemented by device 102 (FIG. 1) over the mmWave link, that a TxOP is to be established to communicate traffic with the AP MLD implemented by device 102 (FIG. 1) over the mmWave link, e.g., as described above.

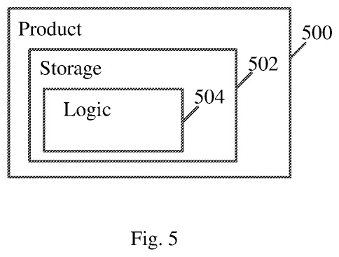

Reference is made to FIG. 5, which schematically illustrates a product of manufacture 500, in accordance with some demonstrative aspects. Product 500 may include one or more tangible computer-readable (“machine-readable”) non-transitory storage media 502, which may include computer-executable instructions, e.g., implemented by logic 504, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1); to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities; and/or to perform, trigger and/or implement one or more operations and/or functionalities described with reference to the FIGS. 1, 2, 3, and/or 4, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 500 and/or machine readable storage media 502 may include one or more types of computer-readable storage media capable of storing data, including volatile memory, non-volatile memory, removable or non-removable memory, erasable or non-erasable memory, writeable or re-writeable memory, and the like. For example, machine readable storage media 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.
Example 1 includes an apparatus comprising logic and circuitry configured to cause a non Access Point (AP) (non-AP) Multi-Link Device (MLD) to, based on a determination that the non-AP MLD is to operate over a millimeter Wave (mmWave) frequency band, operate the non-AP MLD at an Enhanced Multi-Link Single Radio (EMLSR) operation mode of a Multi-Link Operation (MLO) over a plurality of links with an AP MLD, the plurality of links comprising a sub 10 Gigahertz (GHz) (sub-10 GHz) link over a sub-10 GHz frequency band and an mmWave link over the mmWave frequency band; listen over the plurality of links to identify an Initial Control Frame (ICF) from the AP MLD; and identify, based on detection of the ICF from the AP MLD over the mmWave link, that a Transmit Opportunity (TxOP) is to be established to communicate traffic with the AP MLD over the mmWave link
Example 2 includes the subject matter of Example 1, and optionally, wherein the apparatus is configured to cause the non-AP MLD to listen over the sub-10 GHz link for an other ICF from the AP MLD during at least part of the TxOP over the mmWave link
Example 3 includes the subject matter of Example 2, and optionally, wherein the apparatus is configured to cause the non-AP MLD to switch from the mmWave link to the sub-10 GHz link for communication with the AP MLD based on a detection of the other ICF from the AP MLD during the TxOP over the mmWave link
Example 4 includes the subject matter of any one of Examples 1-3, and optionally, wherein the apparatus is configured to cause the non-AP MLD to identify the ICF from the AP MLD according to an mmWave ICF format configured for the mmWave frequency band.
Example 5 includes the subject matter of any one of Examples 1-4, and optionally, wherein the apparatus is configured to cause the non-AP MLD to configure the plurality of links of the EMLSR operation mode to comprise a first mmWave link and a second mmWave link
Example 6 includes the subject matter of Example 5, and optionally, wherein the apparatus is configured to cause the non-AP MLD to configure the first mmWave link and the second mmWave link over a same mmWave channel.
Example 7 includes the subject matter of Example 5 or 6, and optionally, wherein the apparatus is configured to cause the non-AP MLD to configure the first mmWave link and the second mmWave link having a same channel Bandwidth (BW).
Example 8 includes the subject matter of any one of Examples 5-7, and optionally, wherein the apparatus is configured to cause the non-AP MLD to configure the first mmWave link via a first antenna array of the non-AP MLD, and to configure the second mmWave link via a second antenna array of the non-AP MLD.
Example 9 includes the subject matter of any one of Examples 5-8, and optionally, wherein the apparatus is configured to cause the non-AP MLD to configure the first mmWave link via a first antenna sector in a first direction from the non-AP MLD, and to configure the second mmWave link via a second antenna sector in a second direction from the non-AP MLD.
Example 10 includes the subject matter of any one of Examples 5-9, and optionally, wherein the apparatus is configured to cause the non-AP MLD to simultaneously listen for the ICF over the first mmWave link and the second mmWave link
Example 11 includes the subject matter of any one of Examples 5-10, and optionally, wherein the apparatus is configured to mandate the non-AP MLD to configure the plurality of links of the EMLSR operation mode to comprise the first mmWave link and the second mmWave link
Example 12 includes the subject matter of any one of Examples 1-11, and optionally, wherein the apparatus is configured to cause the non-AP MLD to configure the mmWave link according to a Multiple-Input-Multiple-Output (MIMO) beamforming setting in first and second different directions, and to simultaneously listen for the ICF in both the first and second different directions.
Example 13 includes the subject matter of Example 12, and optionally, wherein the apparatus is configured to cause the non-AP MLD to process a field in the ICF from the AP MLD to identify an antenna index of the AP MLD, and, based on the antenna index of the AP MLD, to determine which of the first and second different directions is to be used to establish the TxOP over the mmWave link
Example 14 includes the subject matter of any one of Examples 1-13, and optionally, wherein the apparatus is configured to restrict the non-AP MLD to operate over the mmWave frequency band only at the MLO over the plurality of links comprising at least one sub-10 GHz link and at least one mmWave link
Example 15 includes the subject matter of any one of Examples 1-14, and optionally, wherein the apparatus is configured to restrict the non-AP MLD to operate over the mmWave frequency band only at the EMLSR operation mode.
Example 16 includes the subject matter of any one of Examples 1-15, and optionally, wherein the sub-10 GHz link comprises a sub-7 GHz link over a sub-7 GHz frequency band.
Example 17 includes the subject matter of any one of Examples 1-16, and optionally, wherein the mmWave link is over a channel having a frequency above 40 GHz.
Example 18 includes the subject matter of any one of Examples 1-17, and optionally, wherein the mmWave frequency band comprises a frequency band between 42.5 GHz and 71 GHz.
Example 19 includes the subject matter of any one of Examples 1-18, and optionally, wherein the non-AP MLD comprises an Integrated mmWave (IMMW) non-AP MLD.
Example 20 includes the subject matter of any one of Examples 1-19, and optionally, comprising a radio to receive the ICF from the AP MLD.
Example 21 includes the subject matter of Example 20, and optionally, comprising one or more antennas connected to the radio, and a processor to execute instructions of an operating system of the non-AP MLD.
Example 22 includes a wireless communication device comprising the apparatus of any of Examples 1-21.
Example 23 includes a mobile device comprising the apparatus of any of Examples 1-21.
Example 24 includes an apparatus comprising means for executing any of the described operations of any of Examples 1-21.
Example 25 includes a product comprising one or more tangible computer-readable non-transitory storage media comprising instructions operable to, when executed by at least one processor, enable the at least one processor to cause a wireless communication device to perform any of the described operations of any of Examples 1-21.
Example 26 includes an apparatus comprising: a memory interface; and processing circuitry configured to: perform any of the described operations of any of Examples 1-21.
Example 27 includes a method comprising any of the described operations of any of Examples 1-21.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a non Access Point (AP) (non-AP) Multi-Link Device (MLD) to:
based on a determination that the non-AP MLD is to operate over a millimeter Wave (mmWave) frequency band, operate the non-AP MLD at an Enhanced Multi-Link Single Radio (EMLSR) operation mode of a Multi-Link Operation (MLO) over a plurality of links with an AP MLD, the plurality of links comprising a sub 10 Gigahertz (GHz) (sub-10 GHz) link over a sub-10 GHz frequency band and an mmWave link over the mmWave frequency band;
listen over the plurality of links to identify an Initial Control Frame (ICF) from the AP MLD; and
identify, based on detection of the ICF from the AP MLD over the mmWave link, that a Transmit Opportunity (TxOP) is to be established to communicate traffic with the AP MLD over the mmWave link.

2. The apparatus of claim 1 configured to cause the non-AP MLD to listen over the sub-10 GHz link for an other ICF from the AP MLD during at least part of the TxOP over the mmWave link.

3. The apparatus of claim 2 configured to cause the non-AP MLD to switch from the mmWave link to the sub-10 GHz link for communication with the AP MLD based on a detection of the other ICF from the AP MLD during the TxOP over the mmWave link.

4. The apparatus of claim 1 configured to cause the non-AP MLD to identify the ICF from the AP MLD according to an mmWave ICF format configured for the mmWave frequency band.

5. The apparatus of claim 1 configured to cause the non-AP MLD to configure the plurality of links of the EMLSR operation mode to comprise a first mmWave link and a second mmWave link.

6. The apparatus of claim 5 configured to cause the non-AP MLD to configure the first mmWave link and the second mmWave link over a same mmWave channel.

7. The apparatus of claim 5 configured to cause the non-AP MLD to configure the first mmWave link and the second mmWave link having a same channel Bandwidth (BW).

8. The apparatus of claim 5 configured to cause the non-AP MLD to configure the first mmWave link via a first antenna array of the non-AP MLD, and to configure the second mmWave link via a second antenna array of the non-AP MLD.

9. The apparatus of claim 5 configured to cause the non-AP MLD to configure the first mmWave link via a first antenna sector in a first direction from the non-AP MLD, and to configure the second mmWave link via a second antenna sector in a second direction from the non-AP MLD.

10. The apparatus of claim 5 configured to cause the non-AP MLD to simultaneously listen for the ICF over the first mmWave link and the second mmWave link.

11. The apparatus of claim 5 configured to mandate the non-AP MLD to configure the plurality of links of the EMLSR operation mode to comprise the first mmWave link and the second mmWave link.

12. The apparatus of claim 1 configured to cause the non-AP MLD to configure the mmWave link according to a Multiple-Input-Multiple-Output (MIMO) beamforming setting in first and second different directions, and to simultaneously listen for the ICF in both the first and second different directions.

13. The apparatus of claim 12 configured to cause the non-AP MLD to process a field in the ICF from the AP MLD to identify an antenna index of the AP MLD, and, based on the antenna index of the AP MLD, to determine which of the first and second different directions is to be used to establish the TxOP over the mmWave link.

14. The apparatus of claim 1 configured to restrict the non-AP MLD to operate over the mmWave frequency band only at the MLO over the plurality of links comprising at least one sub-10 GHz link and at least one mmWave link.

15. The apparatus of claim 1 configured to restrict the non-AP MLD to operate over the mmWave frequency band only at the EMLSR operation mode.

16. The apparatus of claim 1, wherein the mmWave link is over a channel having a frequency above 40 GHz.

17. The apparatus of claim 1 comprising a radio to receive the ICF from the AP MLD.

18. The apparatus of claim 17 comprising one or more antennas connected to the radio, and a processor to execute instructions of an operating system of the non-AP MLD.

19. A product comprising one or more tangible computer-readable non-transitory storage media comprising instructions operable to, when executed by at least one processor, enable the at least one processor to cause a non Access Point (AP) (non-AP) Multi-Link Device (MLD) to:
based on a determination that the non-AP MLD is to operate over a millimeter Wave (mmWave) frequency band, operate the non-AP MLD at an Enhanced Multi-Link Single Radio (EMLSR) operation mode of a Multi-Link Operation (MLO) over a plurality of links with an AP MLD, the plurality of links comprising a sub 10 Gigahertz (GHz) (sub-10 GHz) link over a sub-10 GHz frequency band and an mmWave link over the mmWave frequency band;
listen over the plurality of links to identify an Initial Control Frame (ICF) from the AP MLD; and
identify, based on detection of the ICF from the AP MLD over the mmWave link, that a Transmit Opportunity (TxOP) is to be established to communicate traffic with the AP MLD over the mmWave link.

20. The product of claim 1, wherein the instructions, when executed, cause the non-AP MLD to listen over the sub-10 GHz link for an other ICF from the AP MLD during at least part of the TxOP over the mmWave link.
